(19) United States
(12) Patent Application Publication
(10) Pub. No.: US 2019/0147065 A1
(43) Pub. Date: May 16, 2019

(54) METHOD AND SYSTEM FOR VERIFICATION OF DELETED DATA FOR BLOCKCHAINS

(71) Applicant: International Business Machines Corporation, Armonk, NY (US)

(72) Inventors: Kumiko Maeda, Tokyo (JP); Munetaka Ohtani, Fujisawa-shi (JP); Yutaka Oishi, Kawasaki (JP); Chikafumi Yasumoto, Tokyo (JP); Jiayun Zhu, Tokyo (JP)

(21) Appl. No.: 15/814,718

(22) Filed: Nov. 16, 2017

(51) Int. Cl. G06F 17/30; H04L 9/06; H04L 9/32

(52) U.S. Cl. CPC G06F 17/30088; H04L 9/3297; H04L 9/0637

(57) ABSTRACT

A blockchain processing method and system for verification of deleted data for blockchains. An item of data is deleted from a block of a blockchain by: identifying the block of the blockchain storing the item of data; deleting the item of data from the identified block without deleting a hash value associated with the deleted item of data from the identified block; and adding metadata to a new block of the blockchain identifying the deleted item of data. The metadata includes a block identifier (ID) of the identified block as a location of the deleted item of data as well as the hash value associated with the deleted item of data. The block ID may comprise a root hash in a block header of the identified block, a universally unique identifier (UUID) allocated to the identified block, or an offset from the new block to the identified block.

### BACKGROUND

A blockchain is a continuously growing list of records, called blocks, which are linked and secured using cryptography. Blocks store one or more items of data, such as transactions, that are hashed, for example, using the SHA-256 Cryptographic Hash Algorithm, and encoded into a Merkle tree, which is a tree in which every leaf node comprises data and every non-leaf node comprises a cryptographic hash of its child nodes. Each block includes a hash of the previous block's header as a link in order to form the chain, and this iterative process confirms the integrity of the previous blocks all the way back to an original or genesis block.

The blockchain is a distributed database, wherein each node in a network stores its own copy of the blockchain. When a block is created and added to the blockchain, it is then published to the other nodes in the network. A block in the blockchain cannot be altered retroactively without the alteration of all subsequent blocks and the collusion of all of the nodes in the network.

Data quality is maintained by replication across the nodes of the network and computational trust. No centralized official copy of the blockchain exists and no node in the network is trusted more than any other node. This allows participant nodes to verify and audit transactions in the blockchain inexpensively. This makes blockchains potentially suitable for the recording of financial transactions, medical records, and other records management activities.

By replicating data across the nodes of the network, the blockchain eliminates the risks that come with data being held centrally. The network lacks centralized points of vulnerability that can be exploited, and has no central point of failure. By decentralizing data, the blockchain makes the data transparent to every node involved.

By design, blockchains are inherently resistant to modification of the data stored therein. Although there is a known method of deleting data written in a blockchain to reclaim disk space, the deletion of the data cannot be verified.

Thus, there is a need in the art for improvements in blockchain processing systems, and more specifically, for the verification of the deletion of data. The present invention satisfies this need.

### SUMMARY

The invention provided herein has a number of embodiments useful, for example, in blockchain processing methods and systems for verification of deleted data for blockchains. The computer-implemented method and system delete an item of data from a block of a blockchain by: identifying the block of the blockchain storing the item of data; deleting the item of data from the identified block, without deleting a hash value associated with the deleted item of data from the identified block; and adding metadata to a new block of the blockchain identifying the deleted item of data.

The metadata is hashed to create a hash value for the metadata, which is also added to the new block of the blockchain. Specifically, the metadata and the hash value for the metadata are written to a Merkel tree of the new block in the blockchain.

The metadata includes a block ID of the identified block as a location of the deleted item of data. The block ID may comprise a root hash in a block header of the identified block, a universally unique identifier (UUID) allocated to the identified block, or an offset from the new block to the identified block.

The metadata includes the hash value associated with the deleted item of data.

The metadata may also include a universally unique identifier (UUID) allocated to the deleted item of data.

In addition, the metadata may include additional information for distinguishing the metadata from other items of data.

### DRAWINGS

Referring now to the drawings in which like reference numbers represent corresponding parts throughout:

FIG. 1 depicts a cloud computing environment according to an embodiment of the present invention.

FIG. 2 depicts abstraction model layers according to an embodiment of the present invention.

FIG. 3 illustrates a distributed computing environment used for the blockchain processing according to one embodiment.

FIG. 4 illustrates the format of a typical block in a blockchain.

FIG. 5 illustrates how one or more items of data can be discarded from the block to save space.

FIG. 6 illustrates the structure of a blockchain incorporating verification of deletion of an item of data according to one embodiment of the present invention.

FIG. 7 is a flowchart illustrating the processing steps of the present invention in response to a data deletion request.

FIG. 8 is a flowchart illustrating the processing steps of the present invention in response to a deleted data verification request.

### DETAILED DESCRIPTION

In the following description, reference is made to the accompanying drawings which form a part hereof, and in which is shown by way of illustration one or more specific embodiments in which the invention may be practiced. It is to be understood that other embodiments may be utilized and structural and functional changes may be made without departing from the scope of the present invention.

Overview

A blockchain is a technology serving as a basis of next-generation transaction applications that can make business processes more efficient while ensuring reliability, accountability, and transparency. The use of the blockchain is not limited to bitcoin, but may be applied to the management of various types of data. In one embodiment, blockchain processing is used to manage records where opt-out is demanded, in which records are deleted when consent to provide the records is withdrawn, and the blockchain itself verifies the deletion.

Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

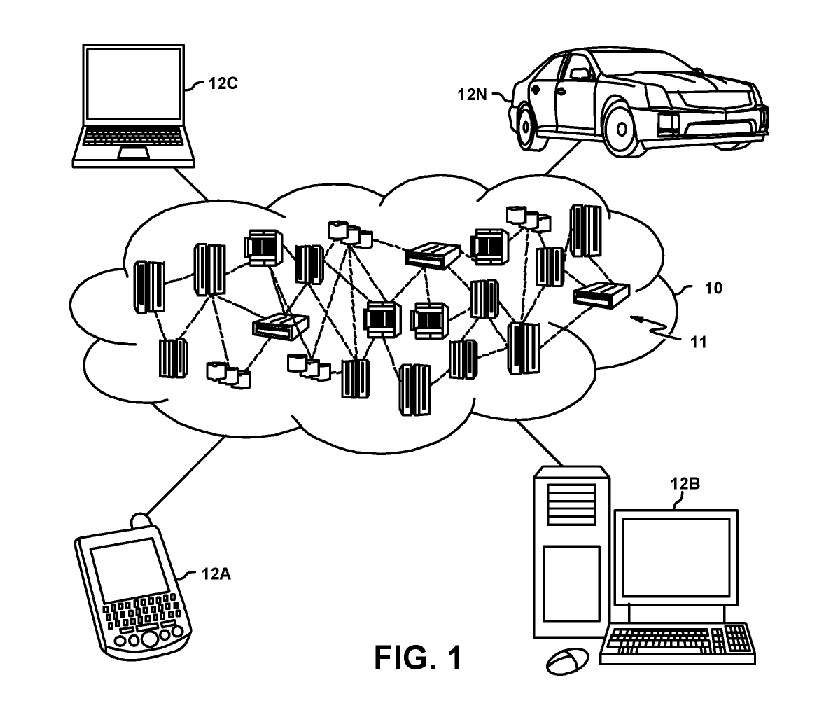

Referring now to FIG. 1, illustrative cloud computing environment 10 is depicted. As shown, cloud computing environment 10 includes one or more cloud computing nodes 11 with which local computing devices used by cloud consumers, such as, for example, personal digital assistant (PDA) or cellular telephone 12A, desktop computer 12B, laptop computer 12C, and/or automobile computer system 12N may communicate. Nodes 11 may communicate with one another. They may be grouped (not shown) physically or virtually, in one or more networks, such as Private, Community, Public, or Hybrid clouds as described hereinabove, or a combination thereof. This allows cloud computing environment 10 to offer infrastructure, platforms and/or software as services for which a cloud consumer does not need to maintain resources on a local computing device. It is understood that the types of computing devices 12A-N shown in FIG. 1 are intended to be illustrative only and that computing nodes 11 and cloud computing environment 10 can communicate with any type of computerized device over any type of network and/or network addressable connection (e.g., using a web browser).

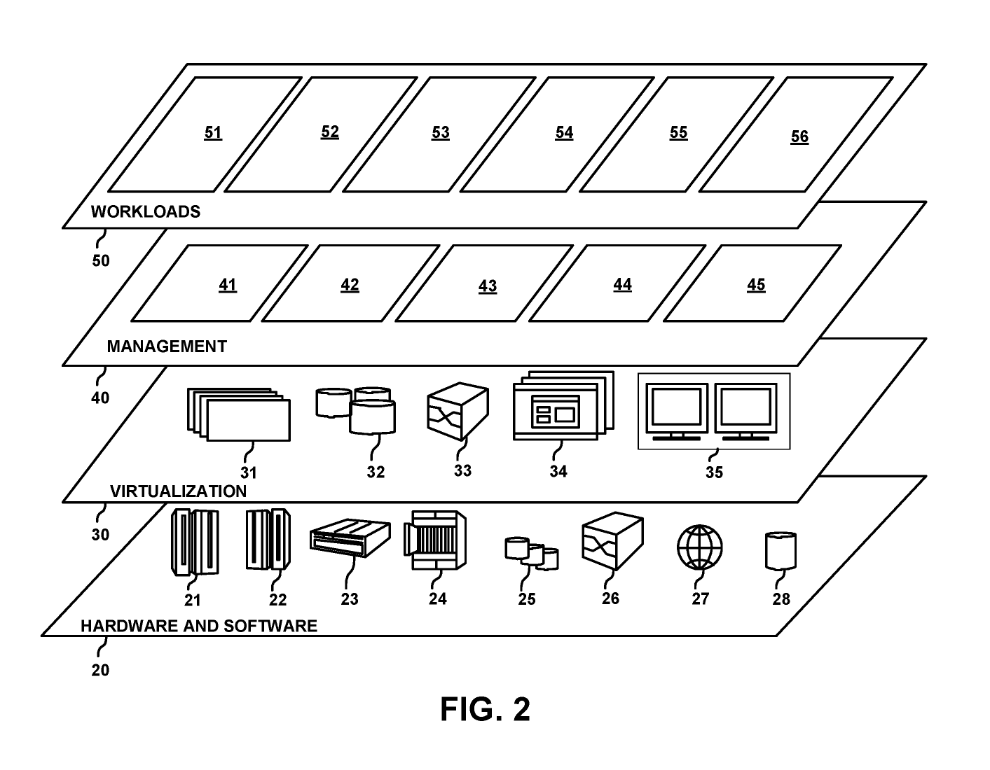

Referring now to FIG. 2, a set of functional abstraction layers provided by cloud computing environment 10 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 20 includes hardware and software components. Examples of hardware components include: one or more computers such as mainframes 21, RISC (Reduced Instruction Set Computer) architecture based servers 22, servers 23, and blade servers 24; storage devices 25; and networks and networking components 26. In some embodiments, software components include network application server software 27 and database software 28.

Virtualization layer 30 provides an abstraction layer from which the following examples of virtual entities may be provided: virtual servers 31; virtual storage 32; virtual networks 33, including virtual private networks; virtual applications and operating systems 34; and virtual clients 35.

In one example, management layer 40 may provide the functions described below. Resource provisioning 41 provides dynamic procurement of computing resources and other resources that are utilized to perform tasks within the cloud computing environment 10. Metering and pricing 42 provide cost tracking as resources are utilized within the cloud computing environment 10, and billing or invoicing for consumption of these resources. In one example, these resources may include application software licenses. Security provides identity verification for cloud consumers and tasks, as well as protection for data and other resources. User portal 43 provides access to the cloud computing environment 10 for consumers and system administrators. Service level management 44, which includes containers, provides cloud computing resource allocation and management such that required service levels are met. Service Level Agreement (SLA) planning and fulfillment 45 provide pre-arrangement for, and procurement of, cloud computing resources for which a future requirement is anticipated in accordance with an SLA.

Workloads layer 50 provides examples of functionality for which the cloud computing environment 10 may be utilized. Examples of workloads, tasks and functions which may be provided from this layer include: blockchain processing 51; transaction processing 52; mapping and navigation 53; software development and lifecycle management 54; virtual classroom education delivery 55; etc.

Distributed Computing Environment

The cloud computing environment 10 of FIGS. 1 and 2 may be used to implement a distributed computing environment. One example of a distributed computing environment comprises the blockchain processing 51 across one or more nodes 11.

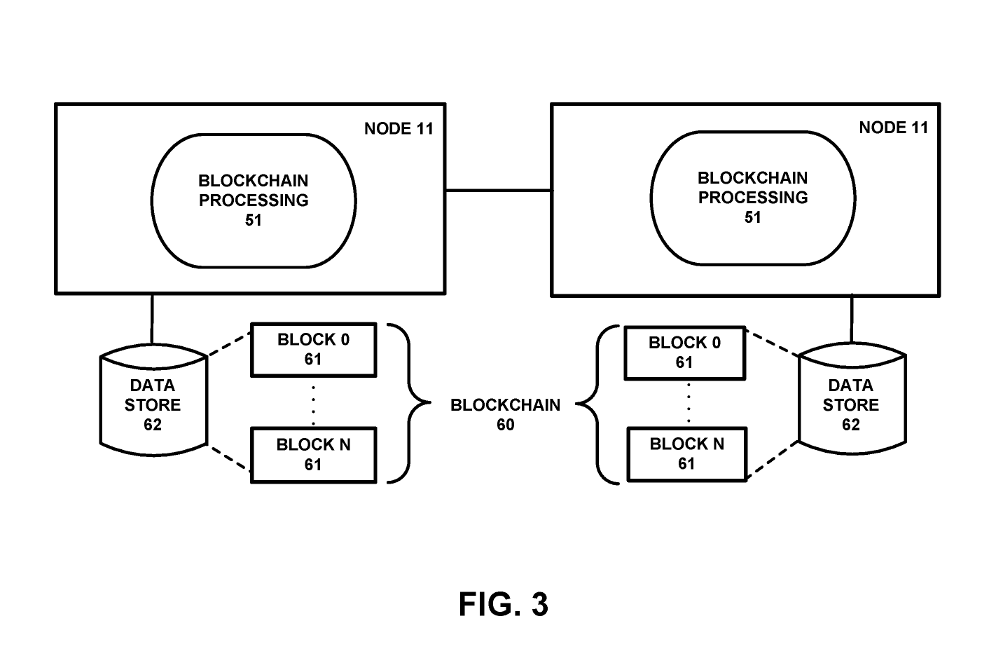

FIG. 3 illustrates a distributed computing environment used for the blockchain processing 51, according to one embodiment. The distributed computing environment used for the blockchain processing 51 is comprised of the following systems and components:
one or more participant nodes 11 that perform the blockchain processing 51 to manage and control one or more blockchains 60;
each blockchain 60 is comprised of one or more linked blocks 61; and
each participant node 11 maintains and stores a copy of the blockchain 60 as a transaction ledger in one or more data stores 62 associated with the node 11.

Although the present invention is described herein as being implemented and stored on the nodes 11 performing the blockchain processing 51, it could be implemented or stored on other nodes 11 as well.

Blockchain Processing

The present invention provides a method and system of verifiable partial deletion of records in a blockchain 60. Specifically, the present invention enables deletion of specific data in the blockchain 60 to be verified to thereby realize the opt-out of the data managed by the blockchain 60 when lineage (traceability of records) data is managed through the blockchain 60.

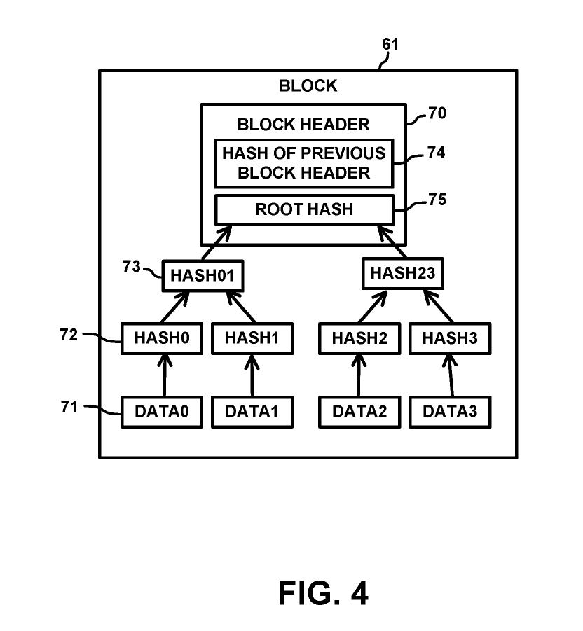

FIG. 4 illustrates the format of a typical block 61 in a blockchain 60. The block 61 includes a block header 70, one or more items of data 71 (Data0, Data1, Data2, Data3), and a hash value 72 (Hash0, Hash1, Hash2, Hash3) for each of the items of data 71, as well as a hash value 73 (Hash01, Hash23) for each non-leaf node of the Merkel tree. The block header 70 includes a hash 74 of the block header 70 in the previous block 61 in the blockchain 60, a root hash 75 for a root node of the Merkle tree, as well as other information (not shown).

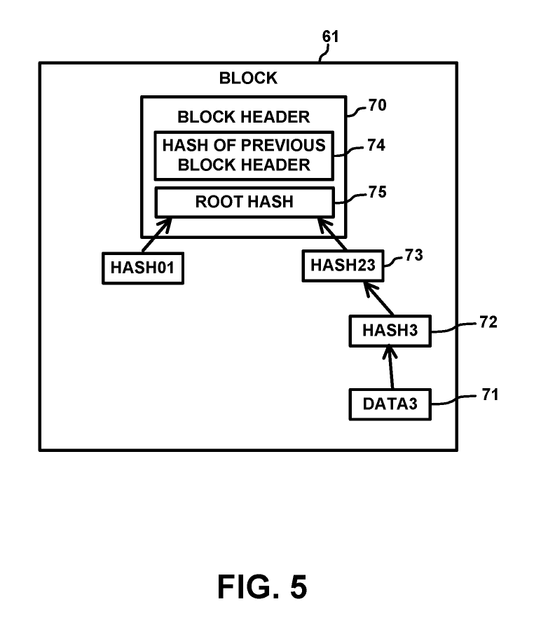

FIG. 5 illustrates how one or more items of data 71 can be discarded from the block 61 to save space. In this example, multiple items of data 71 (Data0, Data1 and Data2, but not Data3) and their associated hash values 72 (Hash0, Hash1 and Hash2, but not Hash3) have been deleted from the block 61.

To facilitate this deletion without breaking the hash 74 of the block header 70 in a next block 61, transactions are hashed in a Merkle tree, as noted above, with only the root hash 75 included in the block header 70. In this way, blocks 61 can then be compacted by stubbing off branches of the Merkel tree, including both items of data 71 and the associated hash values 72.

A problem arises in that deletion of the item of data 71 written in the block 61 of the blockchain 60 cannot be verified. Specifically, although there is a known method of deleting an item of data 71 written in a block 61 to reclaim memory or disk space, the method also deletes the hash value 72 corresponding to the item of data 71 being deleted, and thus the deletion of the item of data 71 cannot be verified.

However, the present invention provides a solution in that, in addition to deletion of the item of data 71 written in the block 61, metadata related to the deleted item of data 71 is registered when a new block 61 is added to the blockchain 60, thereby allowing the deletion of the item of data 71 to be verified. This is described in more detail below.

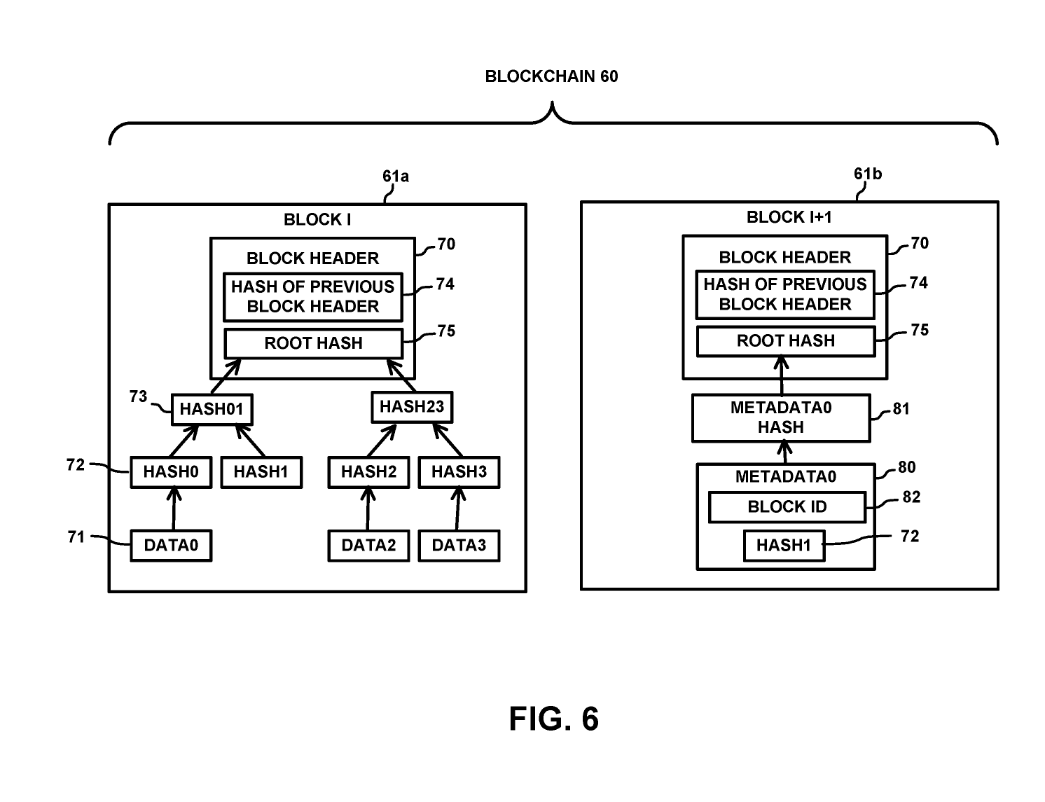

FIG. 6 illustrates the structure of a blockchain 60 incorporating verification of deletion of an item of data 71, according to one embodiment of the present invention. In this blockchain 60, an item of data 71 (i.e. Data1) has been deleted from a block 61a (i.e., Block I), but its associated hash value 72 (i.e., Hash1) has not been deleted from the block 61a. In addition, metadata 80 (Metadata0) has been written to a new block 61b (i.e., Block I+1) along with a hash value 81 (Metadata0 Hash) for the metadata 80, wherein the metadata 80 indicates deletion of the item of data 71 (i.e., Data1), and includes a block identifier (ID) 82 identifying the block 61a as the location of the deleted item of data 71, as well as the hash value 72 (i.e., Hash1) for the deleted item of data 71 (i.e., Data1).

In one embodiment, the root hash 75 for the block 61a is used as the block ID 82. Alternatively, the block ID 82 may be a universally unique identifier (UUID) allocated to the block 61a, or the block ID 82 may be an offset from the new block 61b in which the metadata 80 is registered to the block 61a including the deleted item of data 71. The block ID 82 may also be removed from the metadata 80, if the deleted item of data 71 can be registered without using the block ID 82.

In one embodiment, the hash value 72 (i.e., Hash1) for the deleted item of data 71 is used to identify the deleted item of data 71 (i.e., Data1), in both the block 61a and the metadata 80. However, this requires that the hash value 72 be unique when created. Alternatively, a UUID may be used to identify the deleted item of data 71.

In one embodiment, the metadata 80 may be written and registered in the Merkel tree of the new block 61b, in a manner similar to the items of data 71, which may also be written and registered in the Merkel tree of the new block 61b. However, the metadata 80 will likely include additional information for distinguishing the metadata 80 from the items of data 71. Alternatively, the metadata 80 may be written and registered in the block header 70 of the new block 61b.

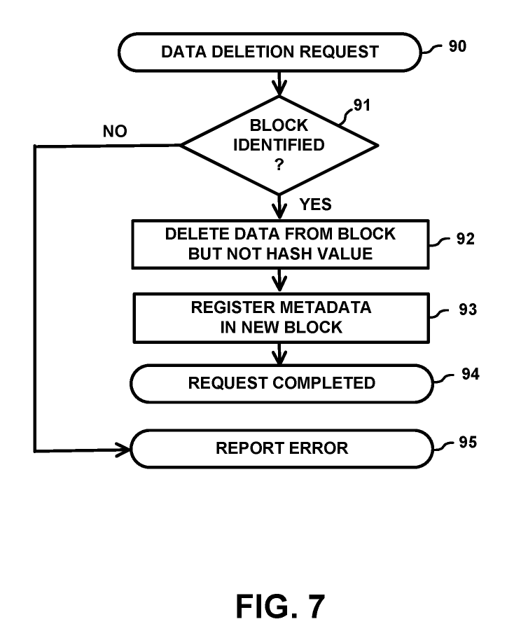

FIG. 7 is a flowchart illustrating the processing steps of the present invention in response to a data deletion request.

Block 90 represents a node 11 receiving a data deletion request identifying an item of data 71 to be deleted.

Block 91 is a decision block that represents the node 11 determining whether there is a block 61 in the blockchain 60 storing the item of data 71 identified by the data deletion request, and identifying the block 61 of the blockchain 60 storing the item of data 71. If so, Block 92 is performed; otherwise, Block 95 is performed.

Block 92 represents the node 11 deleting the item of data 71 from the identified block 61, without deleting a hash value 72 associated with the deleted item of data 71 from the identified block 61.

Block 93 represents the node 11 registering information related to the deleted item of data 71 as metadata 80 and adding the metadata 80 to a new block 61b in the blockchain 60 identifying the deleted item of data 71. The metadata 80 may include the block ID 82 of the block 61 that contained the deleted item of data 71 and the hash value 73 associated with the deleted item of data 72. This step also includes the hashing of the metadata 80 to create a hash value 81 for the metadata 80, and adding the hash value 81 to the new block 61b in the blockchain 60, wherein the metadata 80 and the hash value 81 are written to a Merkel tree of the new block 61b. In addition, this step includes the hashing of the Merkel tree in the new block 61b to create the root hash 75 in the block header 70 of the new block 61b, and the hashing of the block header 71 of the previous block 61 in the blockchain 60 to create the hash value 74.

Block 94 represents the node 11 completing the data deletion request.

Block 95 represents the node 11 reporting an error in the data deletion request.

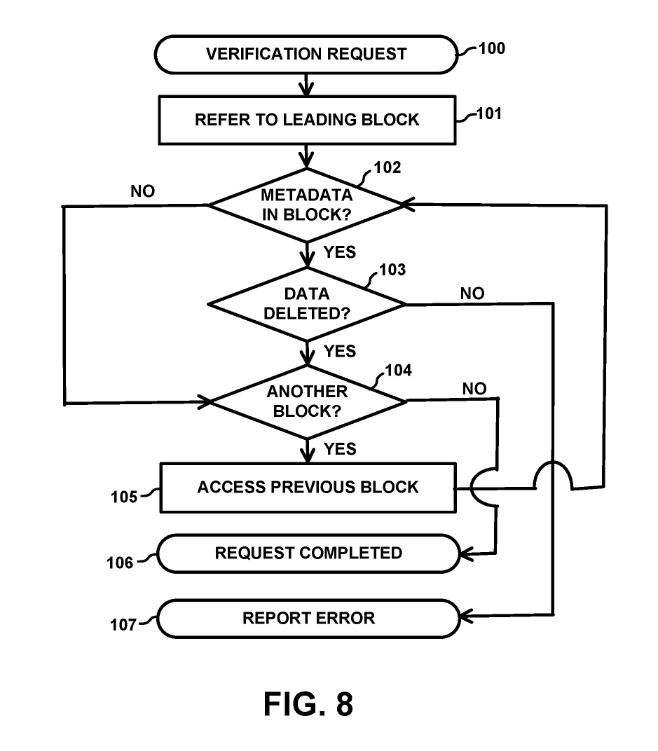

FIG. 8 is a flowchart illustrating the processing steps of the present invention in response to a deleted data verification request.

Block 100 represents a node 11 receiving a deleted data verification request identifying an item of data 71 that has been deleted.

Block 101 represents the node 11 referring to the leading block 61 in the blockchain 60.

Block 102 is a decision block that represents the node 11 determining whether there is metadata 80 in the current block 61 being referenced. If so, Block 103 is performed; otherwise, Block 104 is performed.

Block 103 is a decision block that represents the node 11 determining whether the item of data 71 described in the metadata 80 has been deleted. If so, Block 104 is performed; otherwise, Block 107 is performed.

Block 104 is a decision block that represents the node 11 determining whether there is another unreferenced block 61 in the blockchain 60. If so, Block 105 is performed; otherwise, Block 106 is performed.

Block 105 represents the node 11 referring to an unreferenced block 61 adjacent (i.e., previous) to the currently referenced block 61, and then Block 102 being performed again.

Block 106 represents the node 11 completing the deleted data verification request.

Block 107 represents the node 11 reporting an error in the deleted data verification request.

### Alternative Embodiments

The following describes alternative embodiments of the invention.

In another embodiment of the invention, to delete an item of data 71, a specific block 61 may be deleted instead of deleting the item of data 71 in the block 61. In this case, the block header 71 of the block 61 to be deleted can be registered as the metadata 80 in a new block 61 to allow the continuity of the blockchain 60 to be verified. A logical block 61 length for assuming that the length of the block 61 storing N pieces of metadata of the deleted blocks is N+1, instead of N, can be implemented and used, and this enables coexistence with a method in which it is assumed that the blockchain 60 with the longest block 61 is valid.

In another embodiment of the invention, a new item of data 71 can be included in the metadata 80 in addition to the information for designating the item of data 71 to be deleted, and this allows the present invention to be applied to updates of the items of data 71 in the blocks 61 of the blockchain 60.

Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

### CONCLUSION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
deleting an item of data from a block of a blockchain by:
identifying the block of the blockchain storing the item of data;
deleting the item of data from the identified block, without deleting a hash value associated with the deleted item of data from the identified block; and
adding metadata to a new block of the blockchain identifying the deleted item of data.

2. The method of claim 1, further comprising hashing the metadata to create a hash value for the metadata, and adding the hash value for the metadata to the new block of the blockchain.

3. The method of claim 2, wherein the metadata and the hash value for the metadata are written to a Merkel tree of the new block in the blockchain.

4. The method of claim 1, wherein the metadata includes a block identifier (ID) of the identified block as a location of the deleted item of data.

5. The method of claim 4, wherein the block ID comprises a root hash in a block header of the identified block.

6. The method of claim 4, wherein the block ID comprises a universally unique identifier (UUID) allocated to the identified block.

7. The method of claim 4, wherein the block ID comprises an offset from the new block to the identified block.

8. The method of claim 1, wherein the metadata includes the hash value associated with the deleted item of data.

9. The method of claim 1, wherein the metadata includes a universally unique identifier (UUID) allocated to the deleted item of data.

10. A system, comprising:
one or more computers programmed for deleting an item of data from a block of a blockchain by:
identifying the block of the blockchain storing the item of data;
deleting the item of data from the identified block, without deleting a hash value associated with the deleted item of data from the identified block; and
adding metadata to a new block of the blockchain identifying the deleted item of data.

11. The system of claim 10, further comprising hashing the metadata to create a hash value for the metadata, and adding the hash value for the metadata to the new block of the blockchain.

12. The system of claim 11, wherein the metadata and the hash value for the metadata are written to a Merkel tree of the new block in the blockchain.

13. The system of claim 10, wherein the metadata includes a block identifier (ID) of the identified block as a location of the deleted item of data.

14. The system of claim 13, wherein the block ID comprises a root hash in a block header of the identified block.

15. The system of claim 13, wherein the block ID comprises a universally unique identifier (UUID) allocated to the identified block.

16. The system of claim 13, wherein the block ID comprises an offset from the new block to the identified block.

17. The system of claim 10, wherein the metadata includes the hash value associated with the deleted item of data.

18. The system of claim 10, wherein the metadata includes a universally unique identifier (UUID) allocated to the deleted item of data.

19. A computer program product, the computer program product comprising a computer readable storage medium having program instructions embodied therewith, the program instructions executable by one or more computers to cause the computers to perform a method comprising:
deleting an item of data from a block of a blockchain by:
identifying the block of the blockchain storing the item of data;
deleting the item of data from the identified block, without deleting a hash value associated with the deleted item of data from the identified block; and
adding metadata to a new block of the blockchain identifying the deleted item of data.

20. The computer program product of claim 19, further comprising hashing the metadata to create a hash value for the metadata, and adding the hash value for the metadata to the new block of the blockchain.
